(19) United States
(12) Patent Application Publication
(10) Pub. No.: US 2026/0271839 A1
(43) Pub. Date: Sep. 17, 2026

(54) HORTICULTURE COVER SYSTEMS AND METHODS

(71) Applicant: Spencer Scott, Springdale, WA (US)

(72) Inventor: Spencer Scott, Springdale, WA (US)

(21) Appl. No.: 19/565,092

(22) Filed: Mar. 12, 2026

Related U.S. Application Data
(60) Provisional application No. 63/770,860, filed on Mar. 12, 2025.

(51) Int. Cl. A01G 13/26

(52) U.S. Cl. CPC A01G 13/262

(57) ABSTRACT

Horticulture dome systems and methods are disclosed herein. Exemplary horticulture cover systems can include a horticulture dome or tunnel, and a support assembly coupled with the horticulture dome or tunnel. In some cases, the horticulture dome or tunnel includes a frost cover material. In some cases, the horticulture dome or tunnel includes a shade cloth material.

### CROSS-REFERENCES TO RELATED APPLICATIONS

This application claims the benefit of U.S. Provisional Patent Application No. 63/770,860 filed Mar. 12, 2025, the content of which is incorporated herein by reference.

### BACKGROUND OF THE INVENTION

Various protective covers can be used to cover plants. Yet there continues to be a need for new and improved plant cover systems and methods. Embodiments of the instant invention address at least some of these outstanding needs.

### BRIEF SUMMARY OF THE INVENTION

Exemplary horticulture dome and/or tunnel systems and methods disclosed herein can provide unique protective, thermal, and other qualities.

### BRIEF DESCRIPTION OF THE DRAWINGS

FIGS. 1 to 23 depict aspects of horticulture cover systems and methods, including dome and tunnel versions, according to embodiments of the present invention.

### DETAILED DESCRIPTION OF THE INVENTION

All illustrations of the drawings are to be describing selected embodiments of the present invention and are not intended to limit the scope of the present invention. All references of user or users encompass either individual or individuals who would utilize embodiments of the present invention.

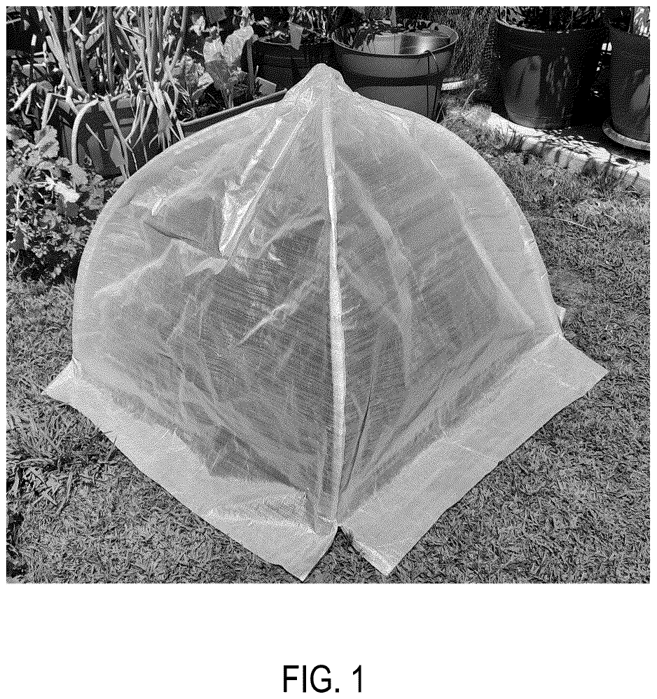

FIG. 1 depicts aspects of a horticulture dome system. The dome system can operate to provide protection for a plant, for example from wind, frost, hail, excessive pelting rain, casual browsing by wildlife, and the like. The dome system can operate to allow heat to build in the soil to allow plants to weather cooler night temps, and continue growing in cooler evening temps. The dome system can operate to provide diffused lighting within the dome, thus enabling a plant to grow within the dome, which is helpful for many plants. The dome system can operate to afford protection for a plant against extreme wind. In some cases, dome systems can be provided in a variety of sizes, such as small medium, and large. In some cases, dome systems can be manufactured from any of a variety of materials, including a shade cloth material, a thrip screen material, a light frost cloth material, and/or a frost cloth liner material.

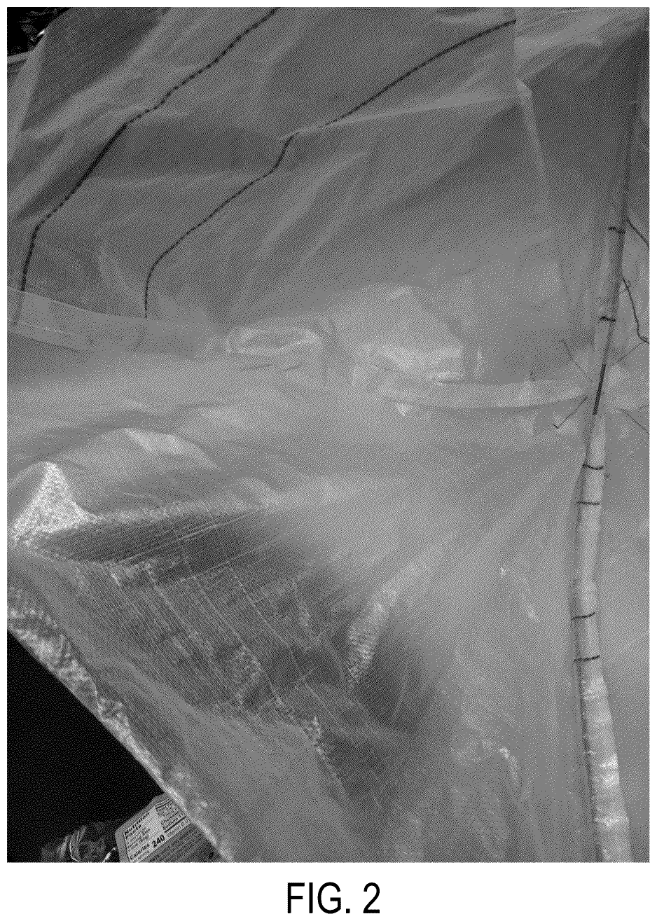

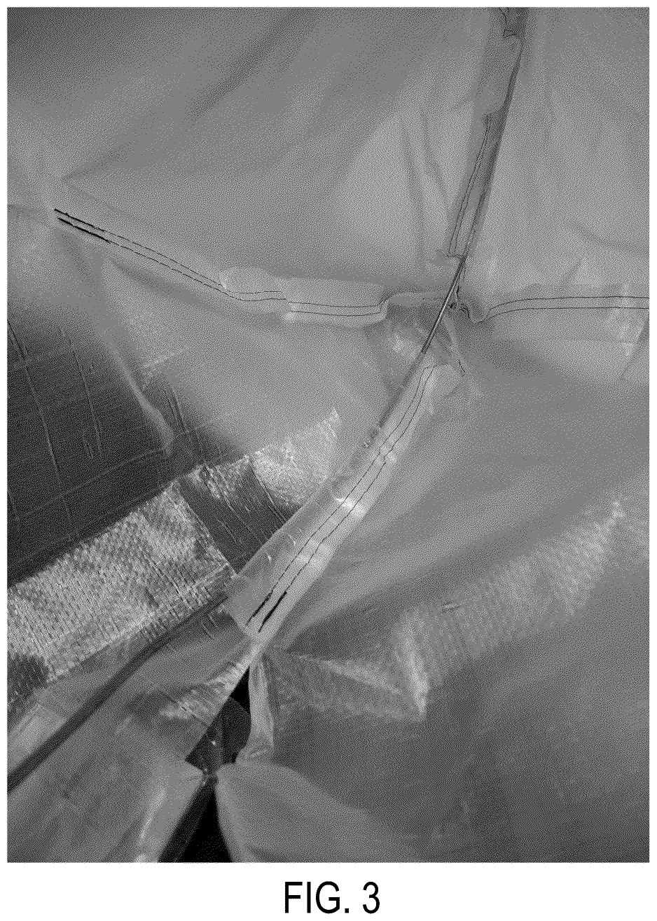

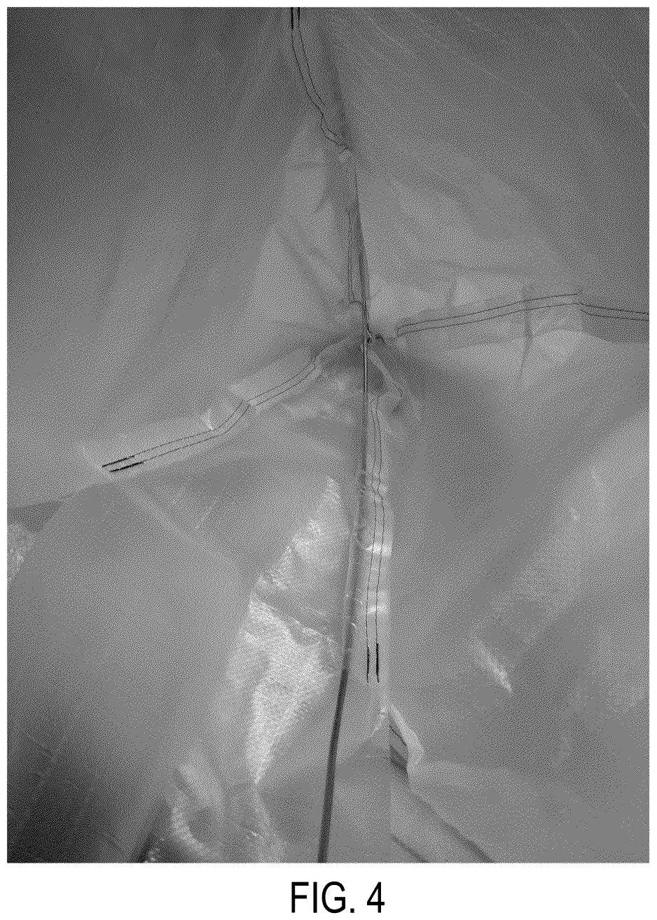

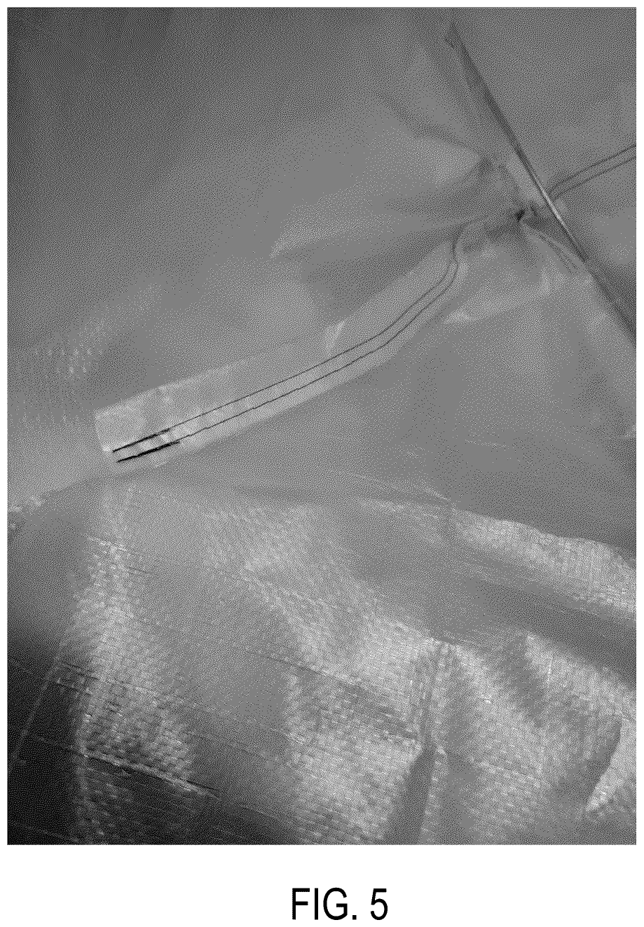

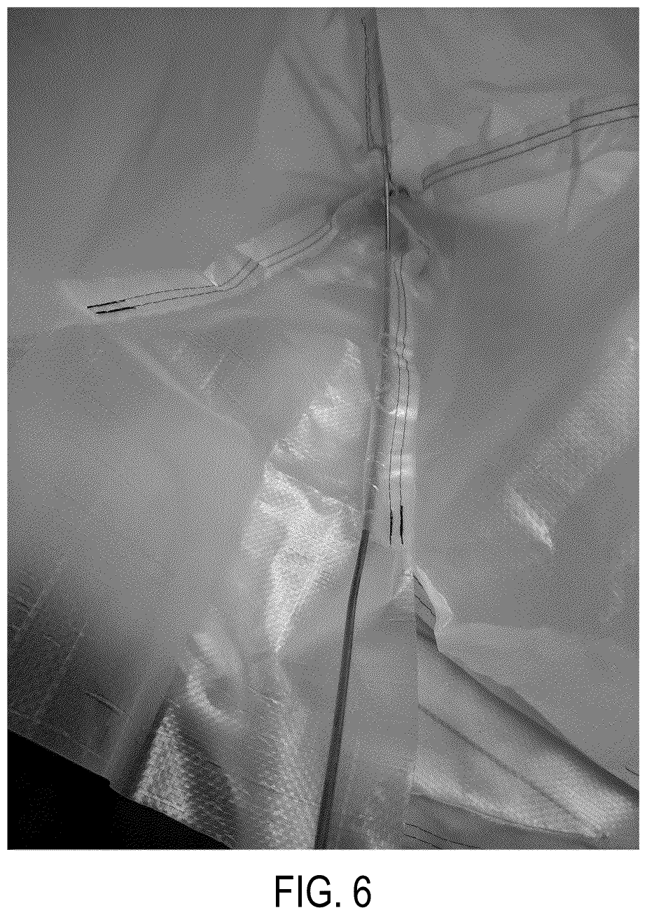

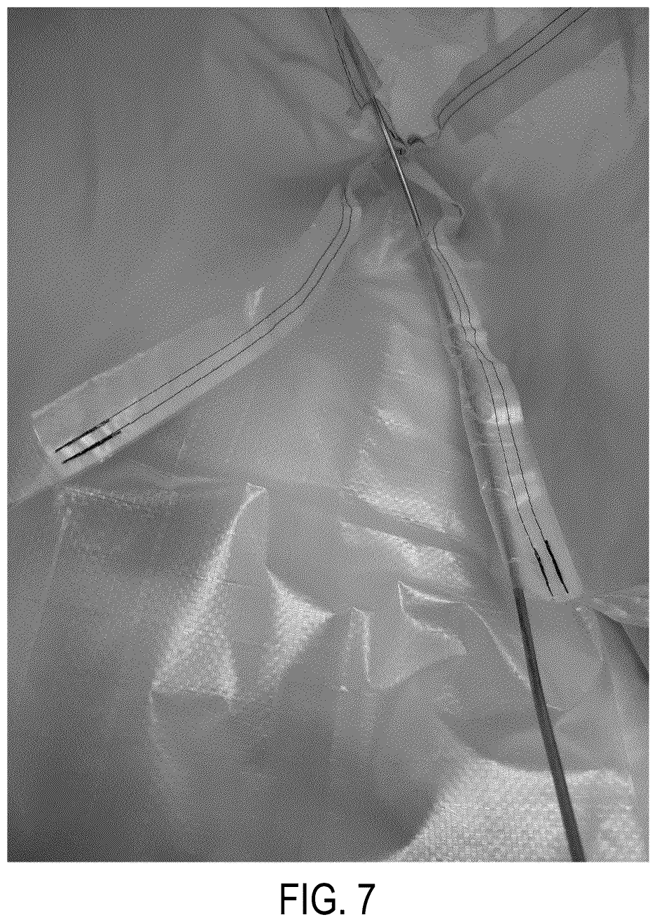

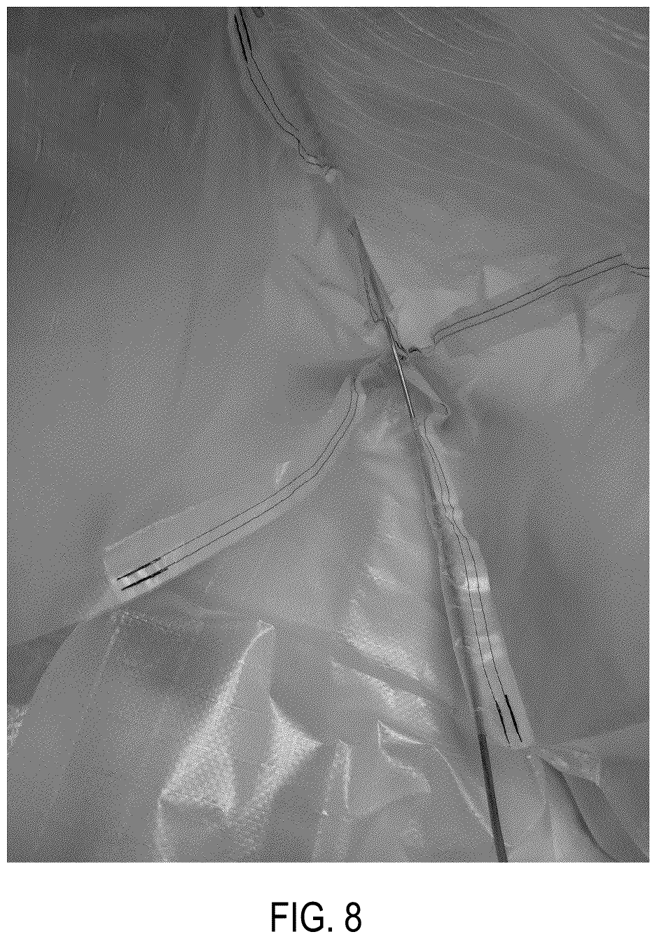

FIGS. 2 to 8 depict aspects of a various horticulture dome system embodiments. According to some embodiments, a horticulture dome, such as a small or medium size horticulture dome, can be supported by 0.090 inch diameter soft galvanized wire, and a large horticulture dome can be supported by 0.060 inch diameter soft galvanized wire. In some embodiments, a horticulture dome can have two wires creating an arch or dome structure or frame supporting the device. In some embodiments, a horticulture dome can include a woven polyethylene fabric. In some embodiments, a horticulture dome can include a fine screen material. In some embodiments, a horticulture dome can include a frost cover cloth material. In some embodiments, a horticulture dome can include a shade cloth material. In some cases, a horticulture dome can include a material that operates to protect a young plant. In some cases, a horticulture dome can operate to provide a plant protection from insects, harsh sunlight, hail, and/or browsing wildlife.

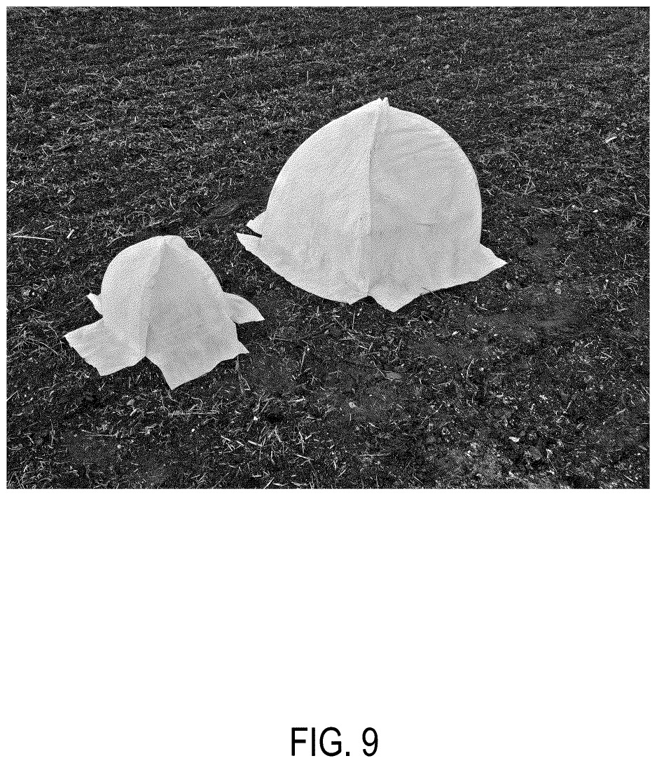

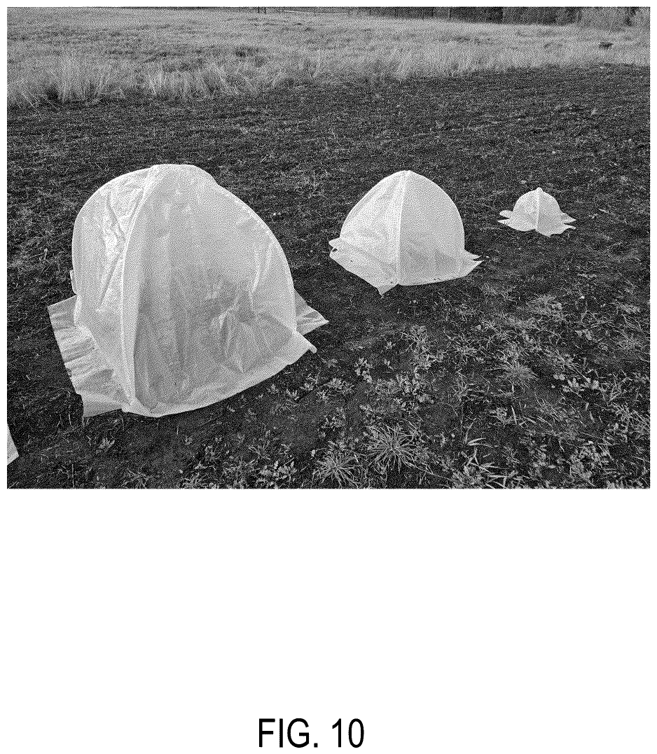

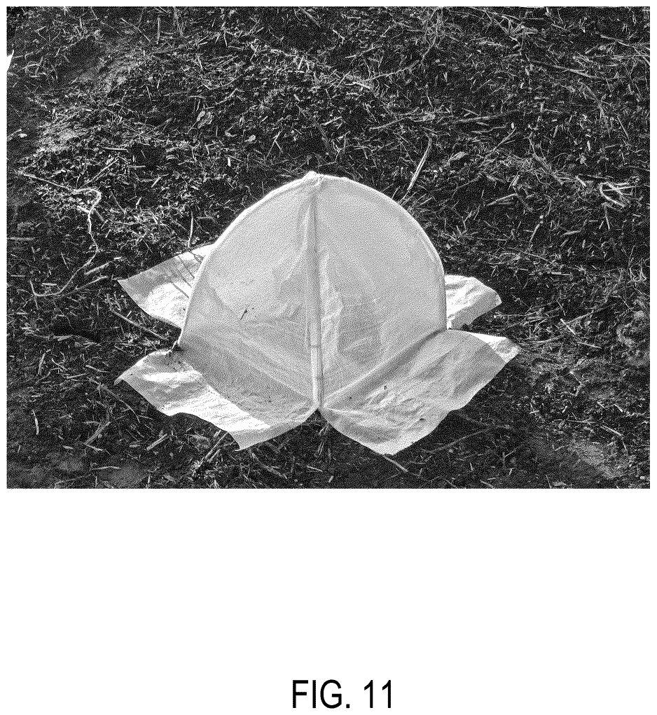

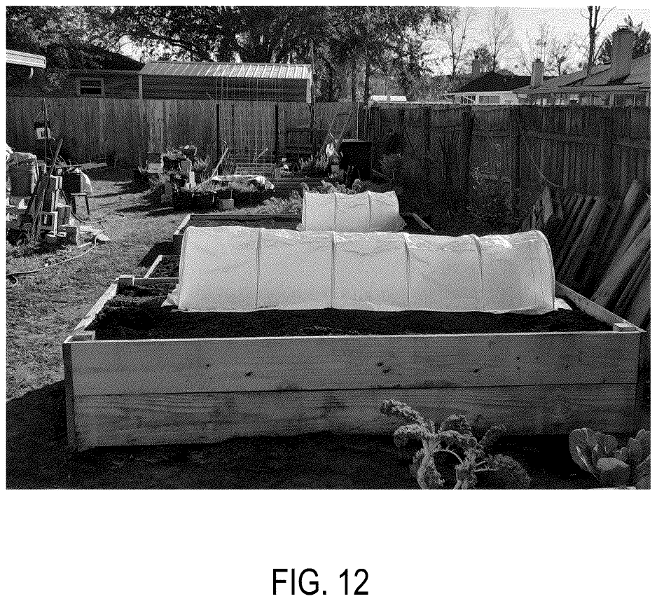

FIGS. 9 to 12 depict aspects of a various horticulture cover system embodiments, including dome and tunnel system embodiments. Three sizes of the Heat Dome embodiments are depicted. In some case, “Large” is 35 inches wide×32 inches in height, “Medium” is 23 inches wide×23 inches in height, and “Small” is 8 ½ inches wide×8 ½ inches tall. In some cases, there are 3 Sizes of “Heat” Tunnels in Medium, 35 inches wide×32 inches in height×6 feet in length, also one at 8 feet in length and one at 10 feet in length. Also Custom sizes upon request. In some cases, there are 3 sizes of Heat Tunnel in Large, 47 inches in width×45 inches in height×6 feet in length, also 8 feet in length and 10 feet in length. Also in Custom sizes upon request. In some cases, Heat Domes and Heat Tunnels can be offered with a three point anchoring system. In some cases, Anchoring System 1: The units “frame” extension beyond the main fabric creates legs that can be pushed into the garden soil up to 5 inches to secure it where it is placed. In some cases, Anchoring System 2: The fabric extensions beyond the primary body that lay flat to the ground, is the second design for soil or rocks to be placed on the side aprons to add weight to the Heat Dome or Heat Tunnel or Frost Cloth Dome or the Screened Dome or the Fine Screened Dome, or the Screen, and Heat fabric variations. Domes or tunnels all the units mentioned above will become more stable in windy conditions due to the added weight, of soil or rocks. In some cases, Anchoring System 3: This design is for windy conditions primarily. In some cases, a loop of fabric is sewn at the location of each rib just below the highest point of the unit. In some cases, these loops are designed as tie off points with a small cord down to a stake forced into the ground. Tied off. That will connect The cord tied on to the loop sewn into the Heat Dome or Heat Tunnel unit Frost Cover Domes Screened Domes Fine Screen, or Regular Screen, the side aprons on all the units are designed as another anchoring feature. By placing soil or rocks on the four apron sides, can act to weigh the unit down to provide more resistance to be the unit all around. In some cases sandbags can be provided, for example at 24 inches in length×4 ½ in diameter to be filled with Aggregate or Sand or soil. In some cases, products come also in 3 fabric variations. 1.) Regular UV stable regular screen, for protection from insects. 2.) The regular screened material creates beneficial insect sequestration area inside the Dome where after the beneficial insects have been placed inside the dome they can prey insects that are infesting the plant needing help. 3) Frost Cover cover Domes.

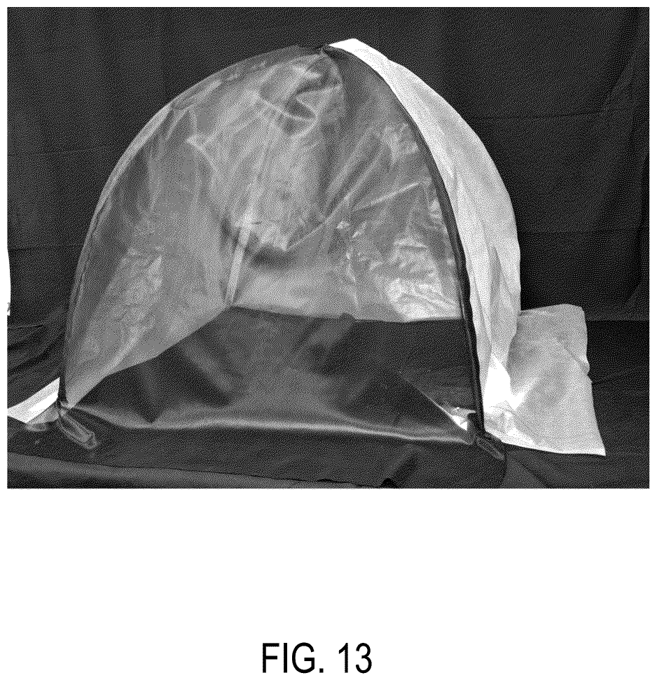

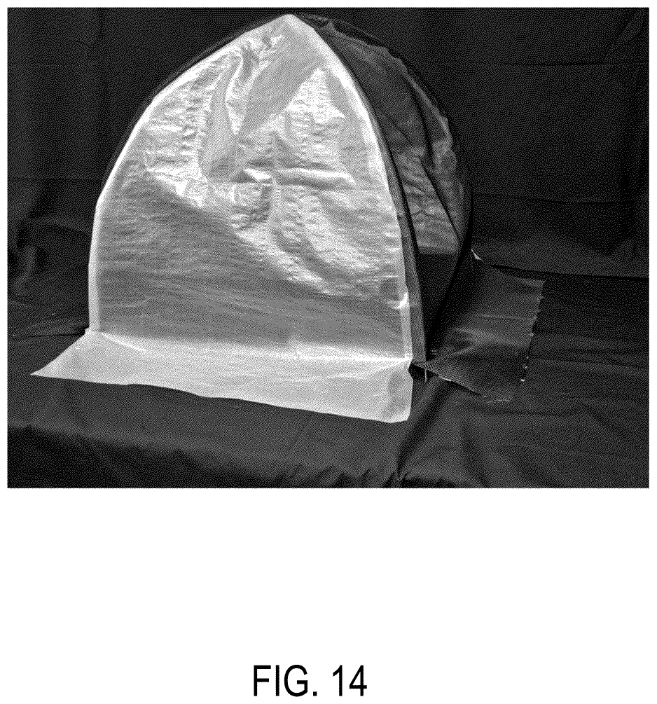

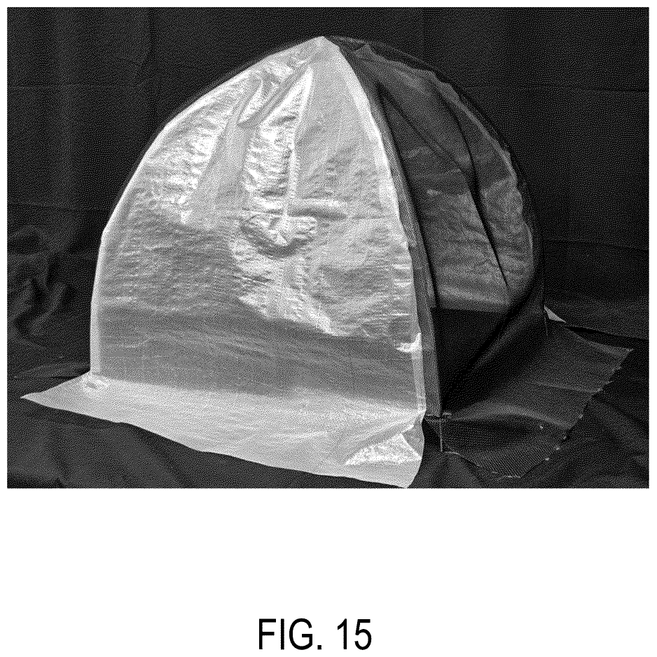

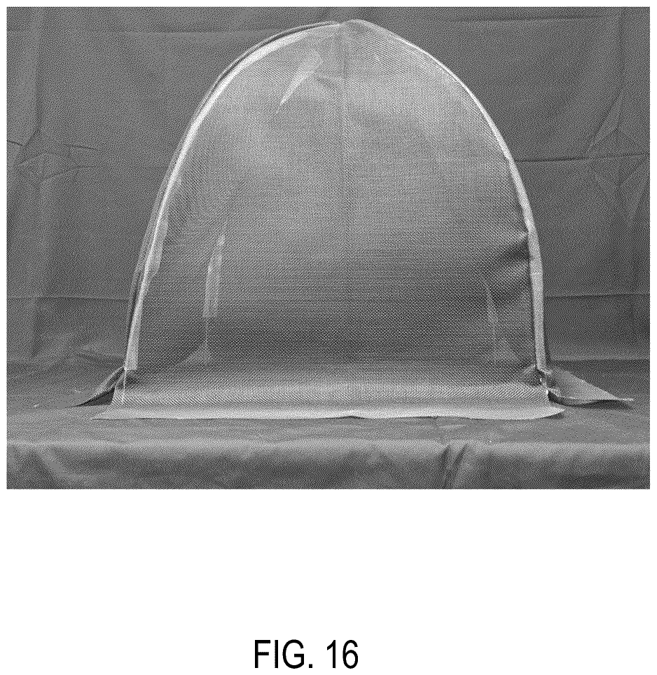

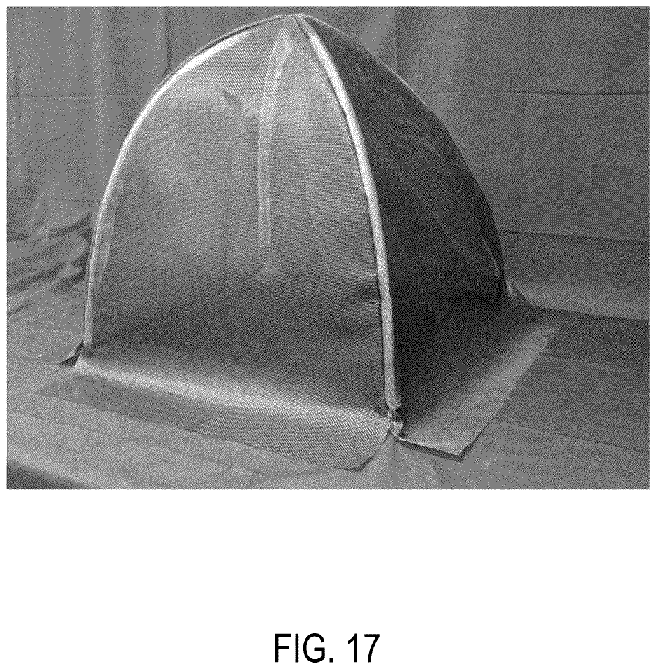

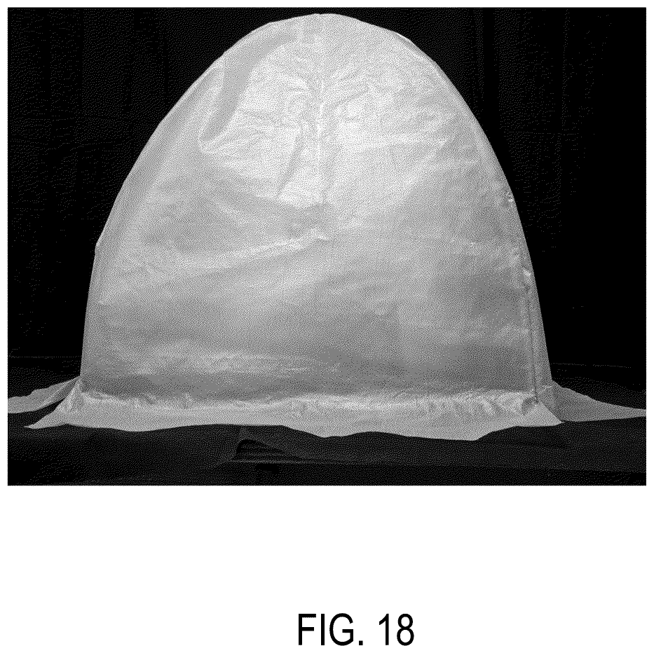

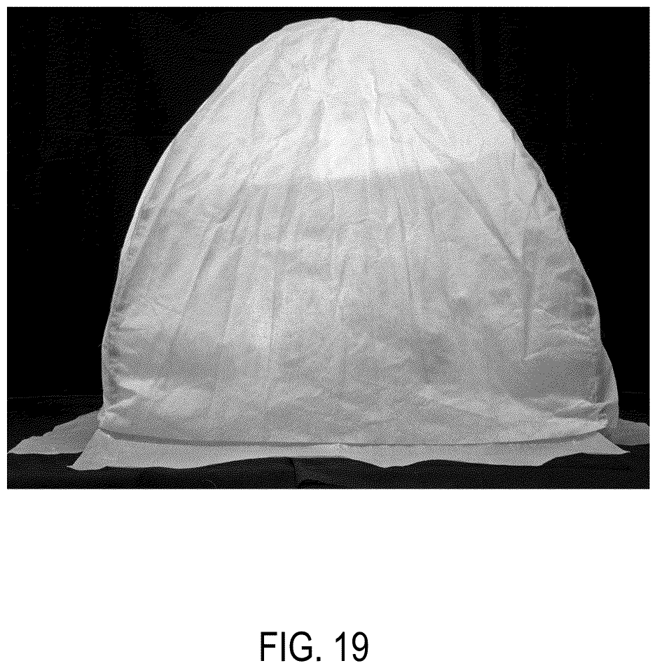

FIGS. 13 to 19 depict aspects of a various horticulture dome system embodiments. As shown here, Heat Domes can be sewn with four equal sections. FIG. 13 is three sections with heat producing fabric and one side fine screen. This is for moderate areas to add heat but with control and have hard rain protection and mite insect control. FIGS. 14 and 15 depict two screened sides and two heat-producing fabric sides. In some cases, there is a selection between fine screen and coarse screen. In some cases, this involves Less heat. In cases, this involves Plus insect control. FIGS. 16 and 17 depict a 100% screen dome for insect control. In some cases, there is a choice between fine screen and a course screen for different prevailing insects by regions in the USA. In some cases, all sizes of domes and tunnels have this option. FIGS. 18 and 19 depict the medium Heat Dome. As shown here, the cover system can have a winter frost cover blanket over it and a second blanket inside. In some cases, this can be provided as a winter system. Such designs have been tested with a tomato plant inside to 25 degrees F. with no frost damage observed.

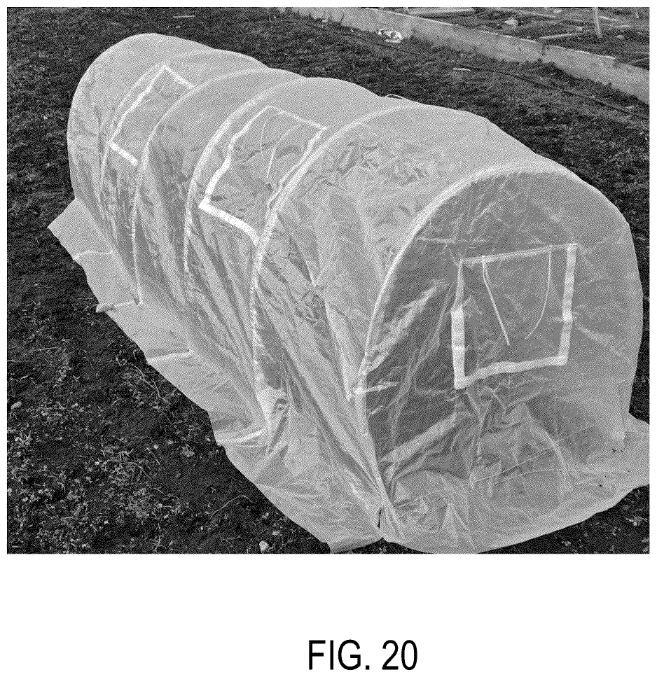

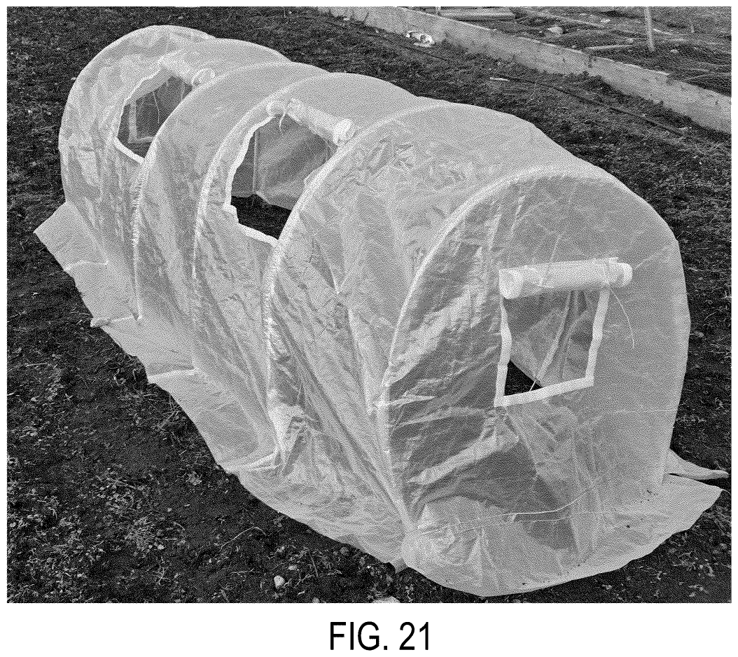

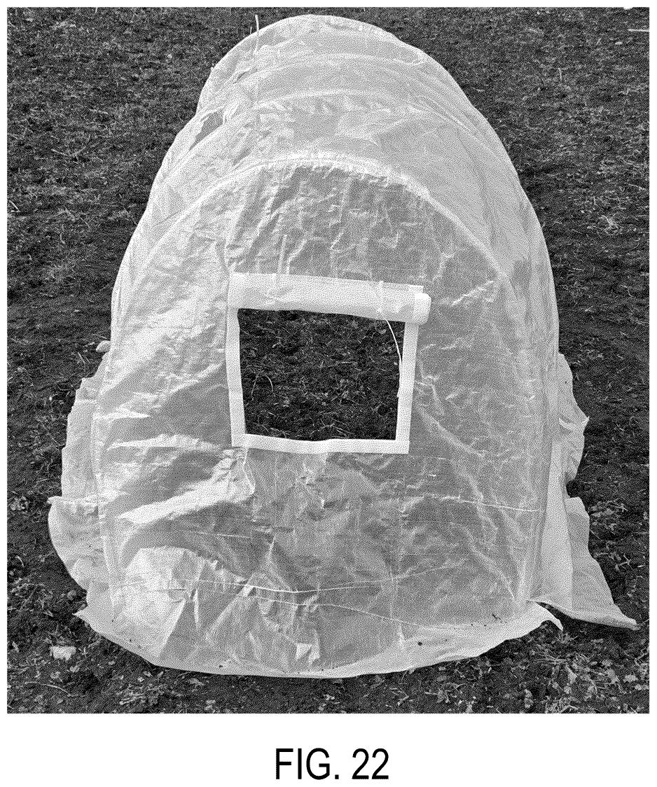

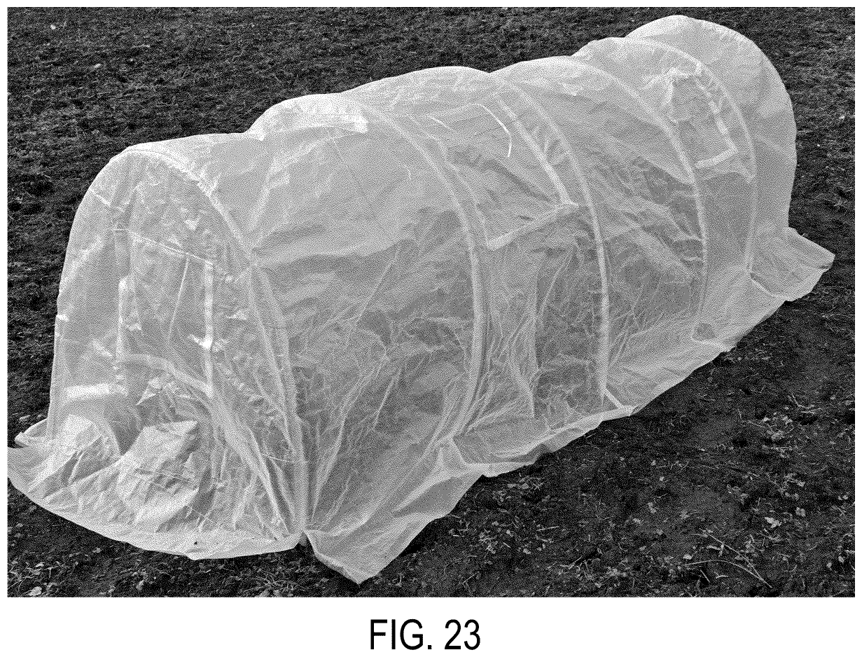

FIGS. 20 to 23 depict aspects of a various horticulture cover system embodiments, including tunnel system embodiments. As shown here, heat tunnels can allow access to plants, and can include openings that are available with a screened opening, or without a screen opening. In some cases, horticulture system embodiments can include options such as anchoring system legs, anchor in ground, or side aprons that allow placement of soil, rocks, or sandbags. In some cases, systems can include loops near the top of dome on all ribs all for a rope a stake tie off for real windy or stormy days. Embodiments of the present invention encompass heat tunnel versions with open access points for heat release and plant management, with screened access and non-screened access. In some cases, systems include a three-point anchoring system and can be provided as an option with a winter protection system.

In some cases, sewing methods used to produce the dome and/or tunnel cover embodiments disclosed herein can provide significant savings in time. In some embodiments, domes are sewn together in 4 cloves with the wire 0.90 or 0.60 channel flute that holds the supporting wire is sewn together as the individual sections are sewn. In some cases, the units are sewn with inside facing out. In some cases, all the channels for the wire on the domes stop inches from the top. Techniques such as these can speed up the assembly time of the wire placement. In some cases, the sewing methods disclosed herein can result in a reduction by ⅔ of the sewing time. In some cases, when the last clove section on the dome is sewn the sewing is completed.

Each reference provided herein is incorporated by reference in its entirety to the same extent as if each reference were individually incorporated by reference. Relatedly, all publications, patents, patent applications, journal articles, books, technical references, and the like mentioned in this specification are herein incorporated by reference to the same extent as if each individual publication, patent, patent application, journal article, book, technical reference, or the like was specifically and individually indicated to be incorporated by reference.

Although embodiments of the present invention have been explained in relation to one or more preferred embodiments, it is to be understood that many other possible modifications and variations can be made without departing from the spirit and scope of the invention.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

In this detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although the foregoing invention has been described in some detail by way of illustration and example for purposes of clarity of understanding, one of skill in the art will appreciate that certain changes, modifications, alternate constructions, and/or equivalents may be practiced or employed as desired, and within the scope of the appended claims. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components. It is intended that the following claims define the scope of the invention and that methods and structures within the scope of these claims and their equivalents be covered thereby.

What is claimed is:

1. A horticulture cover system, comprising:
a horticulture dome; and
a support assembly coupled with the horticulture dome.

2. The horticulture cover system according to claim 1, wherein the horticulture dome comprises a frost cover material.

3. The horticulture cover system according to claim 1, wherein the horticulture dome comprises a shade cloth material.
